(19) United States
(12) Patent Application Publication
(10) Pub. No.: US 2003/0083921 A1
(43) Pub. Date: May 1, 2003

(54) Methods and systems for exchanging information, such as information related to recruiting foreign personnel for domestic-based companies

(76) Inventors: La Verne Clark, Marietta, GA (US); Wayne T. Myers, Pittsfield, MA (US)

Correspondence Address: PERKINS COIE LLP, PATENT-SEA, P.O. BOX 1247, SEATTLE, WA, 98111-1247, US

(21) Appl. No.: 10/066,388

(22) Filed: Oct. 29, 2001

(51) Int. Cl. G06F 17/60

(52) U.S. Cl. 705/8

(57) ABSTRACT

Methods and systems for exchanging information related to recruiting new employees. In one embodiment, the system can be implemented by a user, such as a human resources manager of a foreign division of a domestic-based company, to coordinate the recruiting and training of local nationals for employment by the foreign division. In this embodiment, the method is implemented on a general-purpose computer by the user who accesses a site on a server computer. From this site, the user can request a user interface display page for entering information about a foreign national the user is contemplating hiring. Such information can include the employee type and the location of the foreign division. By submitting this information, the user can obtain information related to recruiting the foreign national.

### BACKGROUND

The following disclosure relates generally to information exchange systems and, more particularly, to computer-based methods and systems for providing content and forms related to recruiting and training foreign personnel for foreign divisions of domestic-based companies.

Many domestic-based companies have international divisions or subsidiaries in foreign countries around the world. Often, a large percentage of the people who work at these foreign divisions are foreign nationals from the host countries. By hiring foreign nationals, the domestic-based company can avoid the expenses associated with relocating domestic employees to the host country. In addition, having foreign nationals on-board who are familiar with local practices and customs can often facilitate relations with local government agencies and other local businesses. Further, employment of local nationals can enhance a company's image and foster goodwill in the host community.

When a foreign national is recruited to work for a foreign division of a domestic-based company, they will often receive training in such areas as company culture, policies, practices and rules. To reduce cost, this training is usually conducted in a central location, such as the company's home country. For example, if a Indian national is recruited in India to work in an Indian division of a U.S.-based company, this person would be temporarily relocated to the United States for training prior to starting work at the Indian division.

For global companies with many divisions in many different countries, arranging centralized training in the home country for all of the new recruits can require a substantial amount of coordination and effort. For example, temporary visas need to be arranged for each new recruit in addition to temporary housing for the training period. In addition to training, compensation and benefits packages that are consistent with local customs, practices and government standards also need to be developed.

The ability to recruit talented local nationals is often critical to the success of a foreign division. Unfortunately, however, conventional methods for recruiting foreign nationals have traditionally been uncontrolled, cumbersome and time-consuming. In many global companies, for example, each foreign division has its own documents and procedures for hiring foreign nationals, resulting in little consistency between different divisions. Further, recruiting documents are generally not controlled or archived, and hence it is often difficult or impossible to review or reuse documents previously created. For example, it is often difficult for a division in one foreign country to process a U.S. visa for its local nationals due to lack of knowledge of the processes other foreign divisions have used successfully.

These difficulties add significant costs to the recruitment of foreign nationals. Further, these difficulties can make aspects of the recruiting process, such as the domestic-based training portion, appear overly complex and intimidating to the prospective recruit. As a result, many qualified foreign nationals who possess the latest technological skills are often discouraged from applying for available positions. Accordingly, methods and systems that streamline the process for recruiting foreign nationals for foreign divisions of domestic-based companies are desirable.

### BRIEF DESCRIPTION OF DRAWINGS

FIG. 1 is a block diagram illustrating components of a recruiting information exchange system in one embodiment.

FIG. 2 is a flow diagram illustrating a process for obtaining content or forms related to recruiting a foreign national in one embodiment.

FIG. 3 is a flow diagram illustrating a routine for providing employee recruiting information in one embodiment.

FIG. 4 is a diagram illustrating a user interface display page for receiving information about a prospective foreign national employee in one embodiment.

FIG. 5 is a diagram illustrating a display page for presenting a list of recruiting related topics in one embodiment.

FIG. 6 is a diagram illustrating a display page for presenting content related to a recruiting process in one embodiment.

FIG. 7 is a diagram illustrating a display page for presenting content related to compensation development in one embodiment.

FIG. 8 is a diagram illustrating a display page for presenting content related to benefits allocation in one embodiment.

FIG. 9 is a diagram illustrating a display page for presenting a blank form related to documents for U.S.-based training of foreign nationals in one embodiment.

FIG. 10 is a diagram illustrating a display page for presenting content related to commonly used U.S. visas in one embodiment.

FIG. 11 is a diagram illustrating a display page for presenting a landing preparation checklist in one embodiment.

FIG. 12 is a block diagram of a computer system for implementing a recruiting information exchange system in one embodiment.

### DETAILED DESCRIPTION

Methods and systems are described for exchanging information related to recruiting and training new employees, such as new foreign national employees. In one embodiment, the system can be implemented by a user, such as a Human Resources (HR) manager of a foreign division of a domestic-based company, to coordinate the recruiting and training of local nationals for employment by the foreign division. In this embodiment, the system provides guidelines and other information to the HR manager on topics such as employee compensation, employee benefits and domestic-based training. In addition, the system can also provide the HR manager with various blank forms usable in the hiring and training process. These forms can include various visa papers and tax documents that may be required for submission to appropriate government agencies to implement various portions of the process.

In one embodiment, the method is implemented on a general purpose computer, such as a personal computer, and utilized by a user, such as the HR manager, who accesses an HR site on a server computer. From the HR site, the user can request a user interface display page for entering background information about a particular foreign national the user desires to hire. Such background information can include the type of employee and their country of origin. In one embodiment, the type of employee can be either “local national” or “leased,” and the country of origin can be either India, Mexico or Russia. In other embodiments, other types of employees, such as hourly, salaried or part-time, and other countries of origin, such as Japan, Saudi Arabia or Germany, could be included.

After entering this background information, the user selects a submit button to bring up a display page containing topical links to a wide selection of recruiting-and training-related materials. These materials can include content such as guidelines for the recruiting process, employee compensation, employee benefits and domestic-based training. These materials can also include forms such as government visa and tax documents in addition to preparatory checklists. In one aspect of this embodiment, the materials are tailored to the type of employee and the country of origin.

The user can view the materials associated with any topic by selecting the corresponding link. In the case of forms, the user can fill out a form for a particular foreign national by inputting the requested information about the foreign national onto the form. The user can then elect to save the completed form to a storage media, print out a hard copy of the form or send the form via an electronic messaging system, such as email, to another user or government agency for further processing.

Certain embodiments of the methods and systems described for exchanging information related to recruiting and training foreign nationals are described in the context of computer-executable instructions performed by a general-purpose computer, such as a personal computer. In one embodiment, for example, these computer-executable instructions are stored on a computer-readable medium, such as a floppy disk or CD-ROM. In other embodiments, these instructions are stored on a server computer system and accessed via a communications link or computer network, such as an intranet or the Internet. Because the basic structures and functions related to computer-executable routines and corresponding computer implementation systems are well known, they have not been shown or described in detail here to avoid unnecessarily obscuring the described embodiments.

Although the following disclosure provides specific details for a thorough understanding of several embodiments of the recruiting information exchange system, one of ordinary skill in the relevant art will understand that these embodiments may be practiced without some of these details. In other instances, it will be appreciated that the methods and systems described can include additional details without departing from the spirit or scope of the disclosed embodiments.

Although some embodiments are described in the context of recruiting foreign nationals for employment by foreign divisions of domestic-based companies, it will be understood that the methods and systems disclosed are equally usable for recruiting and training foreign nationals for domestic divisions, domestic nationals for domestic divisions or domestic nationals for foreign divisions. Further, it will be appreciated that the methods described for recruiting and training foreign nationals can be apportioned between different users and different computer implementation systems in many different ways depending on the particular application. These and other embodiments will be understood by those of ordinary skill in the relevant art to fall within the scope of the present disclosure.

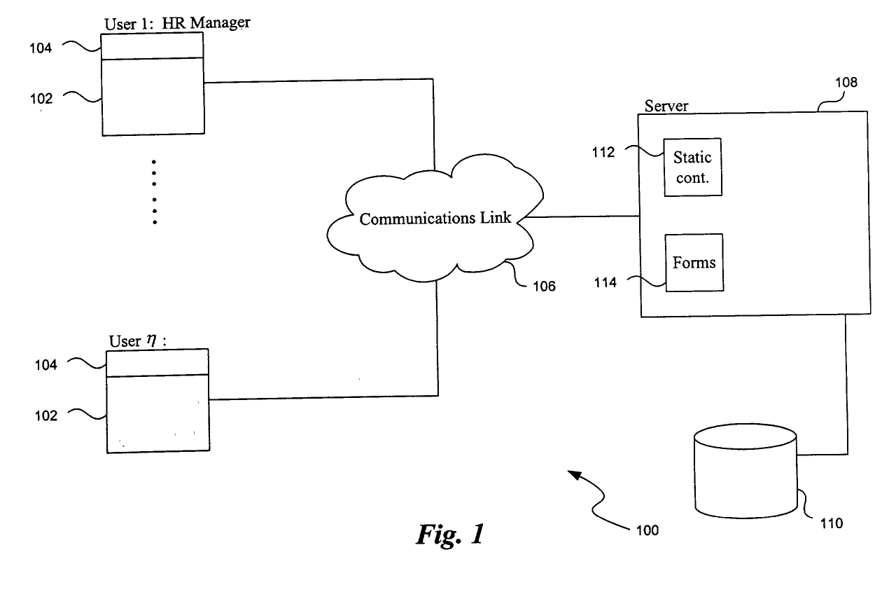

FIG. 1 is a block diagram illustrating components of a recruiting information exchange system 100 in one embodiment. User computers 102 are connected to a server computer 108 via a communications link 106. In one aspect of this embodiment, the communications link 106 is a computer network, such as a local area network (LAN), an intranet or the Internet. The user computers 102 may include a central processing unit, memory devices, input devices (e.g., keyboard and pointing device), output devices (e.g., display devices) and storage devices (e.g., disk drives). The memory and storage devices are computer-readable media that may contain computer instructions for implementing methods and systems, such as routines and display pages, in accordance with this disclosure. The user computers 102 may also include a browser module 104 that allows a user to access and exchange data with the communications link 106, including web sites within the World Wide Web portion of the Internet. In one aspect of this embodiment, the user computers 102 may be operated by various users of the recruiting information exchange system, such as hiring managers or HR personnel at foreign divisions of domestic-based companies.

In one aspect of this embodiment, the server computer 108 includes a content component 112 and a forms component 114. The content component 112 includes static content related to various recruiting-related topics, such as the recruiting process, compensation development, benefits allocation and domestic-based training programs. The term “static content,” as used herein, refers to display pages containing textual information and/or graphics. The forms component 114 includes blank forms, such as government forms for requesting a temporary visa or for setting up tax records, in addition to checklists for making relocation and training preparations. In a further aspect of this embodiment, the server computer 108 is connectable to a database 110. When new forms are created for a new employee, they can be stored in the database 110. The database 110 is searchable to retrieve information related to a specific employee, a specific country, a specific form, a specific technical skill or any other searchable criteria.

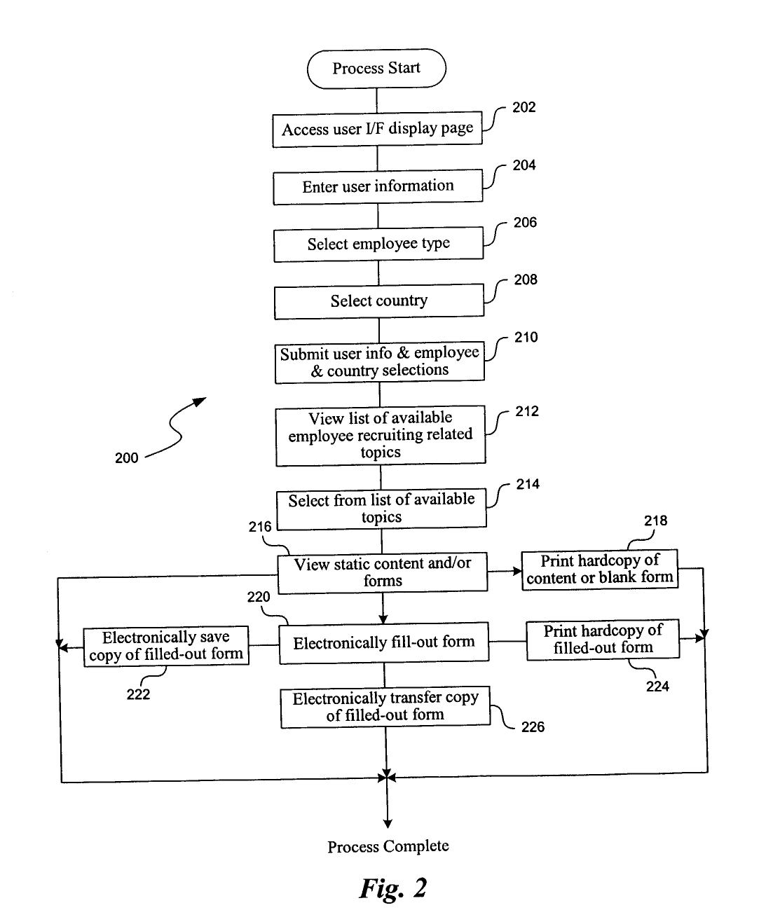

FIG. 2 is a flow diagram illustrating a process 200 for accessing content or forms related to recruiting a foreign national for employment in a foreign division of a domestic-based company in one embodiment. In one aspect of this embodiment, the process 200 may be implemented by a user, such as an HR person at the foreign division, by communication between a general-purpose computer, such as a personal computer, and a server computer, in accordance with computer-executable instructions stored on a computer-readable media.

In block 202, the user begins by accessing a user interface display page for the recruiting information exchange system. In one embodiment, the user accesses this display page by first accessing an HR-site on a server computer. The user then enters their logon ID and password on the HR site and selects an enter button to bring up the user interface display page. In block 204, the user enters their information on the user interface display page. In one embodiment, this user information can include their name, telephone, email address, fax number, and mailing address. In block 206, the user selects an employee type on the user interface display page. In one embodiment, the user can select between a “leased employee” and a “local national employee.” A local national employee is one who is hired directly by the company without the involvement of an agent representing the employee. In contrast, a leased employee is one who is hired through a local supplier or employment agency. Performing the necessary recruiting tasks, such as developing compensation and benefits plans and coordinating domestic-based training, is the joint responsibility of both the company and the employment agency in the recruitment of leased employees.

After selecting an employee type, in block 208, the user selects a country on the user interface display page. In one aspect of this embodiment, the user can select from India, Mexico or Russia, depending on which of these countries the division is located in. In other embodiments in which the company has divisions in other countries, these other countries can also be available for selections. For example, if other divisions of the domestic-based company are located in Germany, France, Italy or Japan, then these countries would similarly be available for selection on the user interface display page. After the user has entered the employee type and country, in block 210, the user selects a submit button to enter the selections.

In one embodiment, a display page containing a list of available informational topics is displayed after the user submits the employee type and country selections. In one aspect of this embodiment, in block 212, the user views this list of topics. These informational topics can relate to employee recruiting and include the recruiting process, compensation development, benefits allocation and domestic-based training. “Domestic-based training” as used herein refers to company training at a central location in the home country of the company. For example, if the company's home base is located in the United States, and the foreign division is located in India, then the new employee would travel to the United States for domestic-based training before returning to India to embark on a career with the foreign division. In addition to the informational topics listed above, the topics of company ground rules, visa document preparation, and training and landing preparations can also be included for local national employees. The additional topics may not be required for leased employees because these matters are handled by their employment agencies, and not by the company.

In block 214, the user selects one of the displayed topics by, for example, “clicking” a pointing device on the topic name. In one embodiment, after the user has selected the topic, information related to that topic is displayed on the user computer for the user to view. In block 216, the user can view the information to learn about particular aspects of employee recruiting. The information may be in the form of static content or blank forms. After viewing the information, the user may elect to exit the process. Conversely, in block 218, the user may elect to print hard copies of selected content and/or blank forms and then exit.

In block 220, the user can fill out forms electronically by entering specified information into various fields on the forms. The user then has a number of options. In block 222, for example, the user may elect to electronically save copies of the forms to a suitable storage media or database for later retrieval or electronic transmission to other users and then exit. Alternatively, in block 224, the user may elect to print hard copies of the filled-out forms and then exit. Finally, in block 226, the user may elect to electronically transfer a copy of a filled-out form to another user via, for example, electronic messaging, such as email. If the user desires, the user may return to the main user interface display page and access other recruiting information or forms related to other types of employees or other countries. Otherwise, the process 200 is complete.

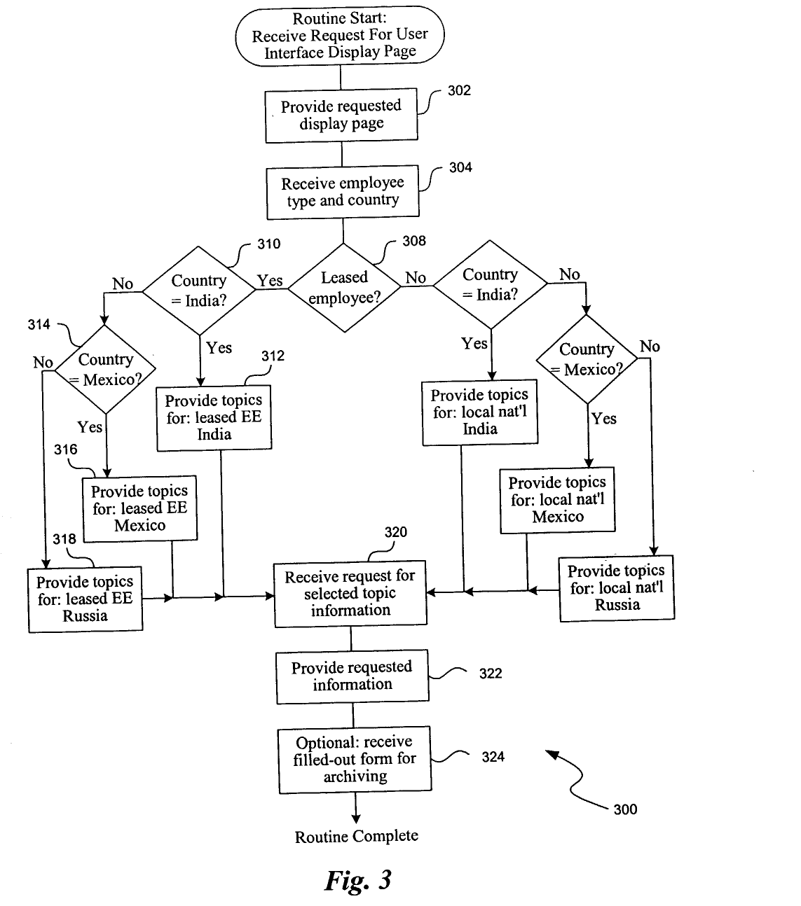

FIG. 3 is a flow diagram illustrating a routine 300 for providing recruiting information in one embodiment. In one aspect of this embodiment, the routine 300 can be implemented on a server computer to provide information, such as content and blank forms related to recruiting foreign nationals for employment by foreign divisions of domestic-based companies, to a user computer. In a further aspect of this embodiment, the routine 300 can be implemented on the server computer in accordance with computer-readable instructions stored on a computer-readable medium, such as a CD-ROM.

The routine 300 starts when it receives a request from the user computer for the recruiting information exchange system user interface display page. In block 302, the routine provides the requested user interface display page to the user computer. In block 304, the routine receives an employee type selection and a country selection from the user computer. In one aspect of this embodiment, the employee type selection can be either local national or leased. In a further aspect of this embodiment, the country selection can be either India, Mexico or Russia. In other embodiments, other employee types and countries can be included depending on where the domestic-based company has its foreign divisions and what types of employees the foreign divisions hire.

In decision block 308, the routine determines if the user selected leased employee or local national employee. If leased employee was selected, then in decision block 310, the routine determines if the user selected the country of India. If India was selected, then in block 312, the routine provides a list of topics containing recruiting information directed toward a leased employee from India to the user computer. If India was not selected, then in decision block 314, the routine determines if Mexico was selected. If Mexico was selected, then in block 316 the routine provides a list of topics directed toward a leased employee from Mexico. If Mexico was not selected, then in block 318, the routine provides a list of topics directed toward a leased employee from Russia.

Returning to decision block 308, if the user selected a local national employee, then the routine proceeds to determine which country the user has selected in a manner substantially similar to that explained above for a leased employee. Accordingly, after the routine determines the selected country, the routine provides a list of topics containing recruiting information directed toward a local national employee from the selected country, in a manner substantially similar to that explained above for the leased employee.

In block 320, the routine receives a request for a selected topic from the user computer. In block 322, the routine provides information related to the requested topic to the user computer. In one aspect of this embodiment, this information includes content explaining certain aspects of the recruiting process or blank forms that can be filled out by the user to facilitate certain aspects of the recruiting process, such as training or temporary relocation. As explained above, the user may elect to print hard copies of the blank forms to be manually filled out and processed. In an alternate embodiment, these forms may be electronically filled out and archived in a suitable database or memory for later searching or retrieval. In this alternate embodiment, in block 324, the routine receives the electronically filled-out form from the user computer for archiving, and the routine is complete.

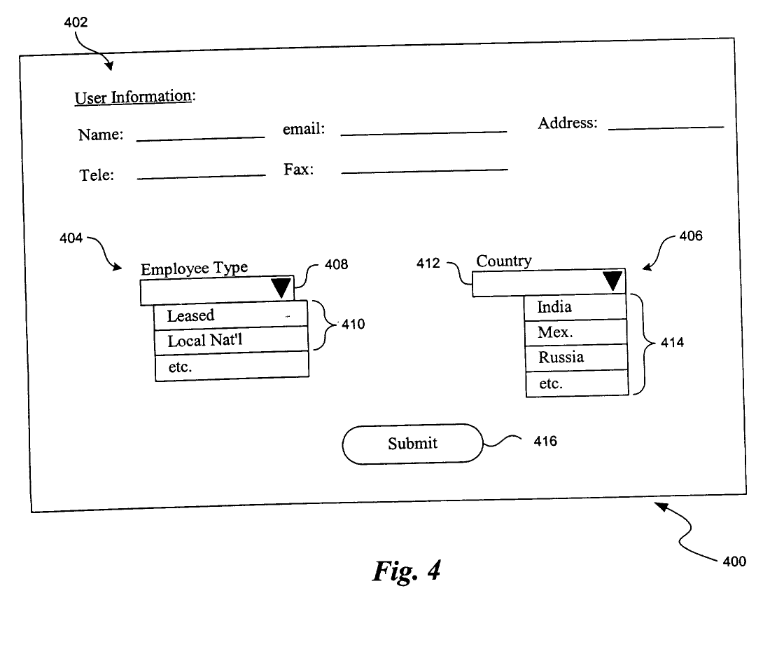

FIG. 4 is a diagram illustrating a user interface display page 400 for receiving information about a prospective foreign national employee in one embodiment. In one aspect of this embodiment, the display page 400 includes a user information portion 402, an employee portion 404 and a country portion 406. In other embodiments, the display page 400 can include other data fields for receiving other types of information related to recruiting employees. For example, in one embodiment, the display page 400 could include additional fields configured to receive information about the skills the prospective employee has or the position the prospective employee seeks. In yet other embodiments, other types of informational input fields could be included in accordance with the present disclosure, as will be recognized by those of ordinary skill in the relevant art.

The user information portion 402 includes a number of fields configured to receive various types of user information. In the illustrated embodiment, this information includes the user's name, email address, mailing address, telephone number and fax number. In other embodiments, other user information could accordingly be included. The employee portion 404 of the illustrated embodiment includes an employee type field 408 and an associated drop-down list 410. The drop-down list 410 includes, at least, both leased employees and local national employees. In other embodiments, other employee types can be included, such as temporary, hourly or salaried employees, etc. The country portion 406 of the illustrated embodiment includes a country identification field 412 and an associated drop-down list 414. The drop-down list 414 includes India, Mexico and Russia. In other embodiments, other countries could be included. The inclusion of other countries would, in one embodiment, depend on which countries the company had divisions in. For example, if the company had divisions in Japan and Italy, then these countries would also be included in the drop-down list 414. Although certain types of employees and user information have been included in the display page 400 for purposes of illustration, it will be apparent to those of ordinary skill in the relevant art that various other types of information could similarly be included to suit particular applications.

Implementation of the display page 400 to collect and transfer employee information in accordance with one embodiment can be accomplished as follows: A user begins by entering the specified user information in the user information portion 402. Next, the type of employee can be selected from the drop-down list 410 for entry into the employee type field 408. Similarly, the country of interest can be selected from the drop-down list 414 for entry into the country identification field 412. Once the user is satisfied that sufficient information has been entered into the display page 400, the user can select or “click” the submit button 416 to transfer the entered information to a remote computer, such as a server computer.

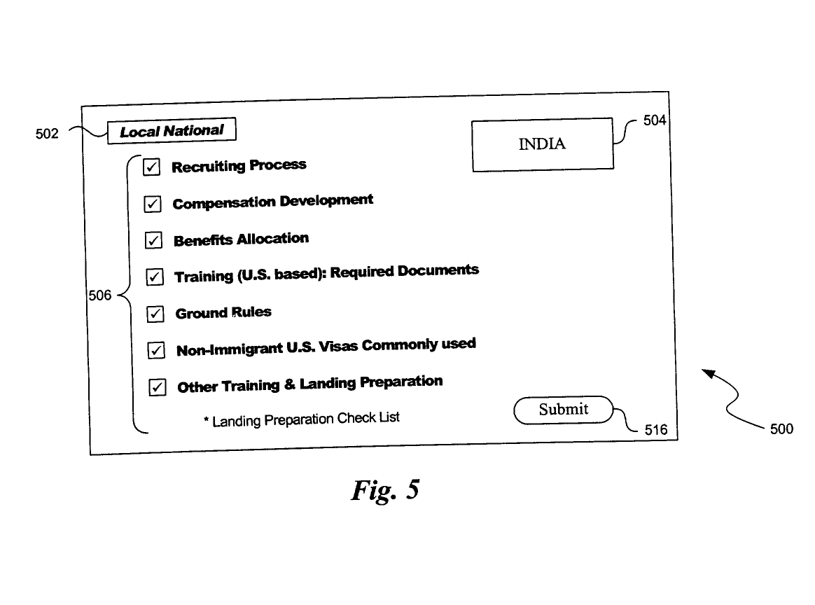

FIG. 5 is a diagram illustrating a display page 500 for presenting a list of recruiting related topics in one embodiment. In one aspect of this embodiment, the recruiting-related topics relate to recruiting a foreign national for employment by a foreign division of a domestic-based company. In a further aspect of this embodiment, the display page 500 includes an employee identifier 502, a country identifier 504 and a topic list portion 506. The identifier 502 and the country identifier 504 identify the employee type and country, respectively, as entered by the user on the display page 400 of FIG. 4.

In one embodiment, the topic list portion 506 includes a list of topics related to different aspects of recruiting foreign nationals for employment by foreign divisions of domestic-based companies. For example, in the illustrated embodiment, these topics can include the recruiting process, compensation development, benefits allocation and U.S.-based training. A portion of the U.S.-based training content can include documents required for obtaining a temporary visa for travel into the United States for training, in addition to other related documents. In the illustrated embodiment, the topic list provided for local national employees further includes ground rules, non-immigrant U.S. visas commonly used, and other training and landing preparation materials. The foregoing three topics are not provided on the analogous display page provided for leased employees because these aspects of recruitment are generally dealt with by the leased employees' employment agencies. In other embodiments, the display page 500 can include more, fewer or different recruitment related topics than those illustrated in FIG. 5 to suit the particular recruiting requirements of a given company or division. The user may access information related to each of the topics displayed on the display page 500 by selecting or “clicking” the box adjacent to the desired topic and then selecting the submit button 516.

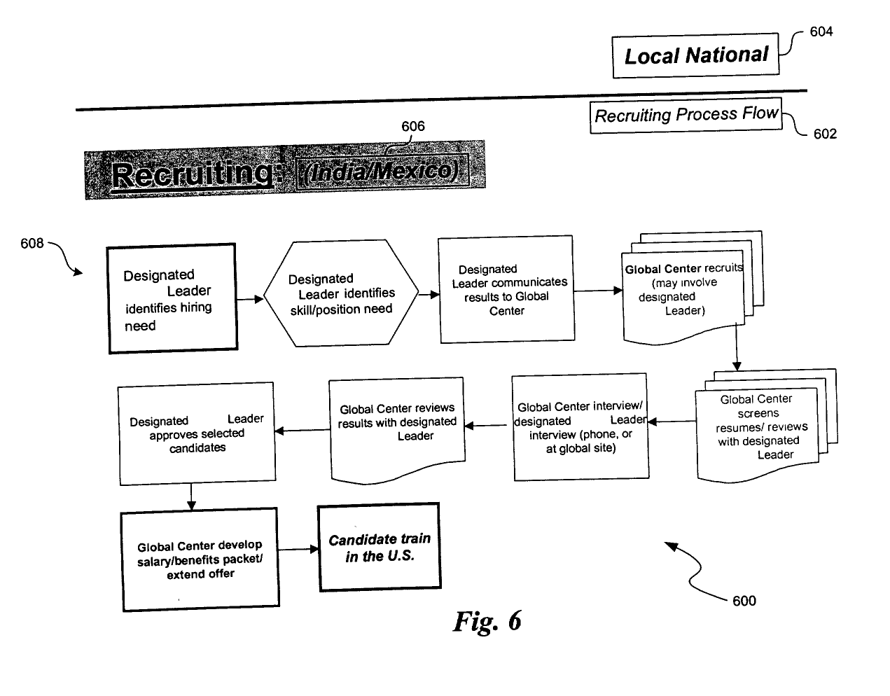

FIG. 6 is a diagram illustrating a display page 600 for presenting content related to a recruiting process in one embodiment. In one aspect of this embodiment, the display page 600 includes a topic identifier 602, an employee identifier 604 and a country identifier 606. Content related to the topic of the recruiting process is presented in a content portion 608. In the illustrated embodiment, the content includes a flow chart outlining the recruiting process flow for a local national employee in either India or Mexico. As will be apparent to those of ordinary skill in the relevant art, numerous other types of content related to the topic of the recruiting process can be presented on the display page 600 in accordance with this disclosure. For example, in one embodiment, textual content in basic page format could be presented. In other embodiments, other types of static content could be presented.

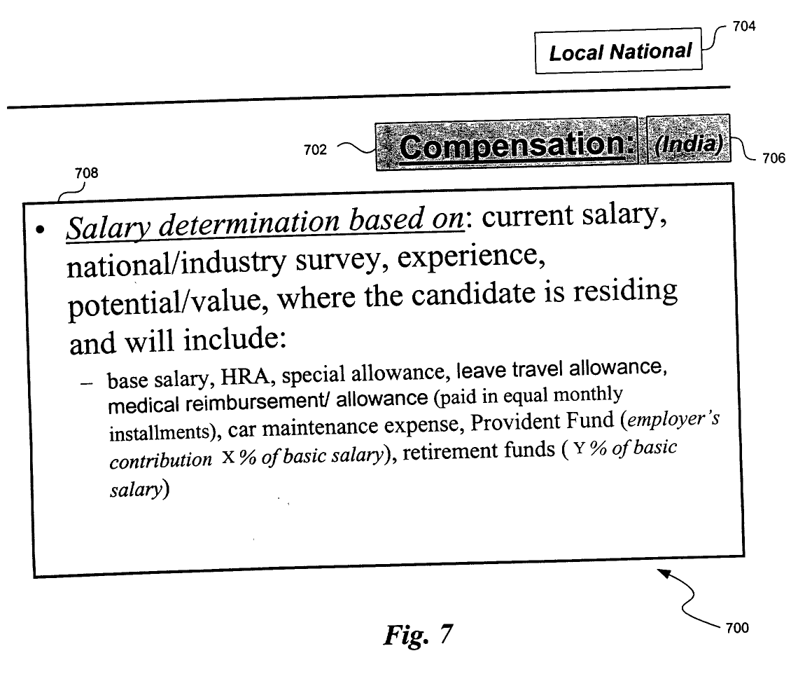

FIG. 7 is a diagram illustrating a display page 700 for presenting content related to the topic of compensation development in one embodiment. In one aspect of this embodiment, the display page 700 includes a topic identifier 702, an employee identifier 704 and a country identifier 706. Content related to the topic of compensation development is included in a content portion 708. In the illustrated embodiment, the content portion 708 includes factors upon which the salary for a foreign national employed by a foreign division of a domestic-based company should be based. In the illustrated embodiment, these factors include current salary, industry survey, experience and potential/value. In other embodiments, other types of content can be presented for the purpose of explaining how to develop a compensation package for a particular employee.

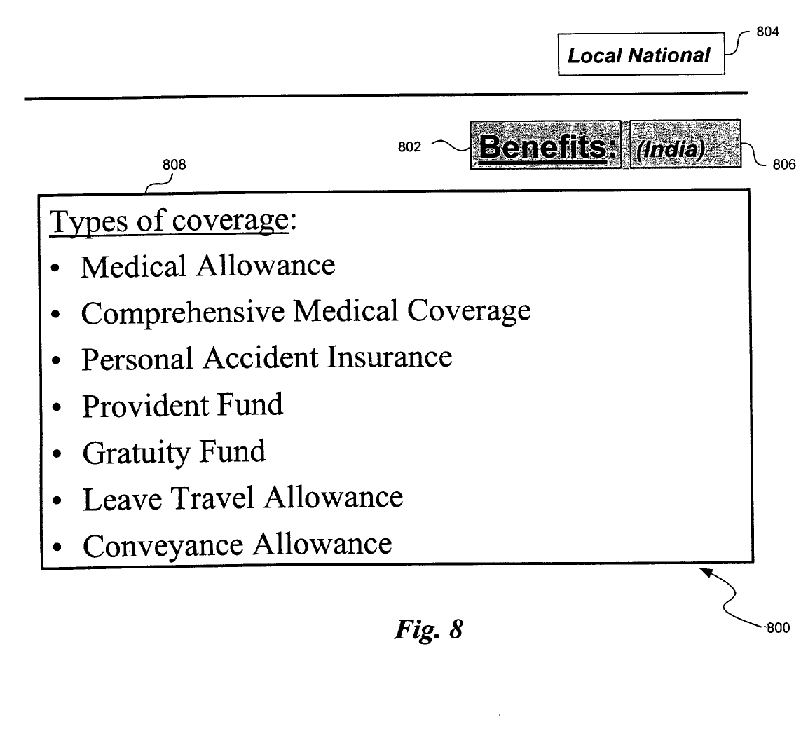

FIG. 8 is a diagram illustrating a display page 800 for presenting content related to the topic of benefits allocation in one embodiment. In one aspect of this embodiment, the display page 800 includes a topic identifier 802, an employee identifier 804 and a country identifier 806. A content portion 808 includes static content related to the subject of benefits allocation for foreign nationals recruited for employment by foreign divisions of domestic-based companies. In the illustrated embodiment, the content portion 808 includes a bullet-point list of types of coverage available to the prospective foreign national employee. In other embodiments, as will be readily apparent to those of ordinary skill in the relevant art, the content portion 808 can include various other types of content related to the subject of employee benefits.

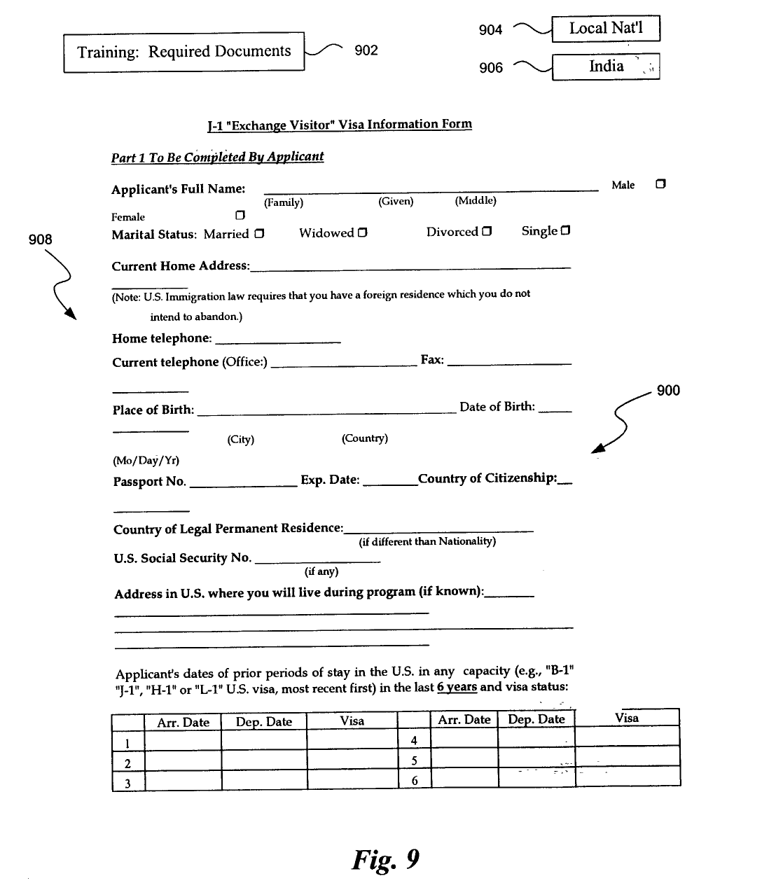

FIG. 9 is a diagram illustrating a display page 900 for presenting a blank form related to the topic of required documents for U.S.-based training of foreign nationals in one embodiment. In one aspect of this embodiment, the display page 900 includes a topic identifier 902, an employee identifier 904 and a country identifier 906. In the illustrated embodiment, a blank form portion 908 is directed to a blank form for collecting visa information. The blank form portion 908 includes various boxes and fields for entering or selecting information related to a particular applicant. In one aspect of this embodiment, the blank form portion 908 is directed toward a J-1 “exchange visitor” visa. As such, this form can include other additional pages (not shown) of similar structure for collecting additional information required to prepare a J-1 visa application. The various fields and boxes illustrated on the display page 900 are self-explanatory to those of ordinary skill in the relevant art, and thus do not require further elaboration here. The display page 900 illustrates only one of the possible blank forms that can be included in the recruiting information exchange system in accordance with the present disclosure. For example, other blank forms can include medical information forms, tax forms, other types of visa forms and virtually any form for obtaining information related to the recruiting process.

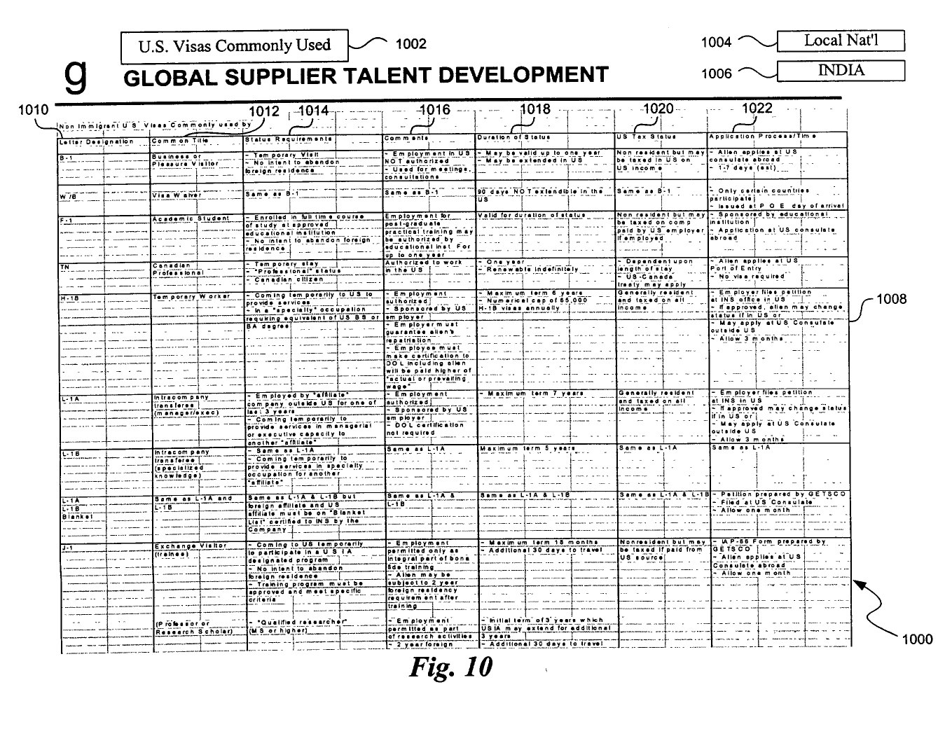

FIG. 10 is a diagram illustrating a display page 1000 for presenting content related to commonly used U.S. visas in one embodiment. In one aspect of this embodiment, the display page 1000 is presented as a table to provide pertinent information about various types of visas for arranging travel to the United States for foreign nationals. In a further aspect of this embodiment, the display page 1000 includes a topic identifier 1002, an employee identifier 1004 and a country identifier 1006. A content portion 1008 includes a visa designation column 1010, a visa title column 1012, a visa requirements column 1014, a comments column 1016, a visa duration column 1018, a tax status column 1020 and an application process/timeline column 1022. Columns 1012-1022 contain general information about the corresponding visa type listed in the adjacent visa designation column 1010. In one aspect of this embodiment, a user, such as an HR manager, can use the display page 1000 as a quick-reference guide to obtain information related to the various visas. As will be apparent to those of ordinary skill in the relevant art, the illustrated embodiment of FIG. 10 is one possible format for a display page containing content related to visas. In other embodiments, other types of content can be presented in accordance with this disclosure.

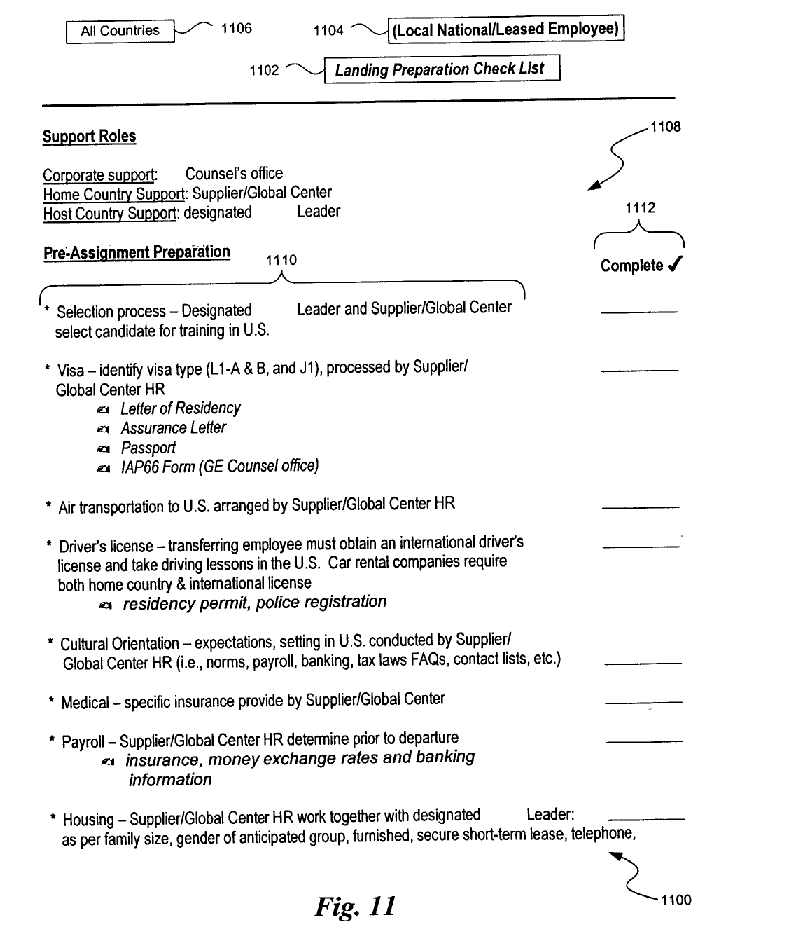

FIG. 11 is a diagram illustrating a display page 1100 for presenting a landing preparation checklist in one embodiment. As used herein, the term “landing” refers to a foreign national arriving in the United States for U.S.-based training. In one aspect of this embodiment, the display page 1100 includes a topic identifier 1102, an employee identifier 1104 and a country identifier 1106. In the illustrated embodiment, the checklist applies to both local national and leased employees and all countries. A checklist portion 1108 includes a preparation step column 1110 and a completion column 1112. The preparation step column 1110 includes preparatory steps such as making visa preparations, arranging air transportation to the United States, making driver's license arrangements and arranging for cultural orientation and housing. In other embodiments, various other preparatory steps can be included depending on the particular circumstances. Upon completion of the presented steps, a user, such as an HR manager, simply checks off the step in the completion column 1112.

Although a number of different display descriptions, including both content and blank forms have been described above in accordance with FIGS. 6-11, those of ordinary skill in the relevant art will understand that various other formats and subject matters can be included in accordance with the present disclosure. Accordingly, the foregoing display descriptions are not intended to represent the preferred or only display page configurations possible.

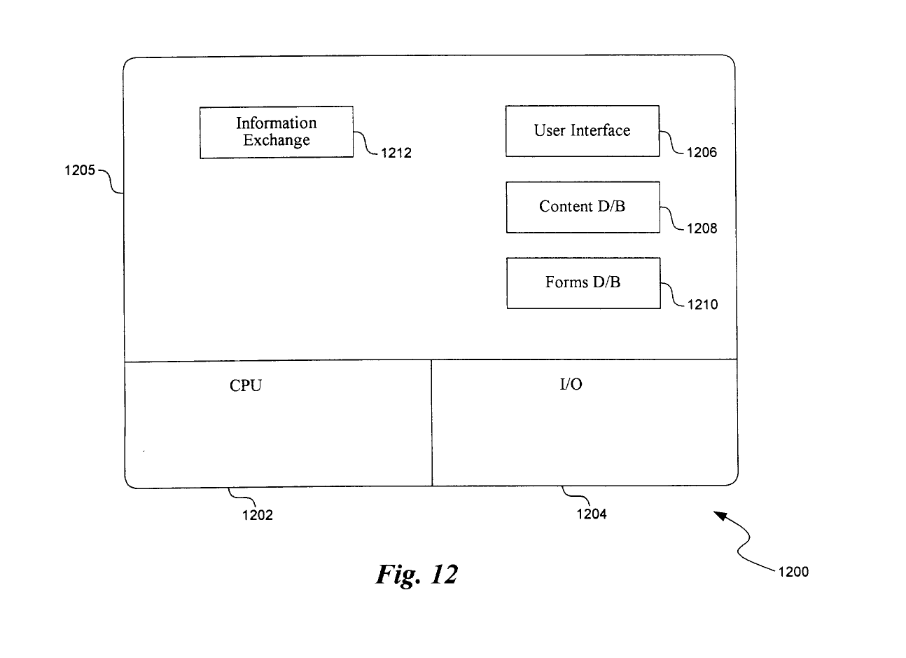

FIG. 12 is a block diagram of a computer system 1200 for implementing a recruiting information exchange system in accordance with an embodiment. The computer system 1200 includes a central processing unit (CPU) 1202, input /output (I/O) devices 1204 and a memory 1205. The CPU 1202 can include circuitry for performing computer functions, such as executing software to perform desired routines and other tasks. The I/O devices 1204 can include automatic input devices, such as a computer-readable media drive, or manual input devices, such as a keyboard or a mouse, for inputting data into the CPU 1202. The I/O devices 1204 can also include output devices coupled to the CPU 1202, such as a printer or a display screen, for displaying, printing or otherwise outputting data such as content or forms.

The memory 1205 can include storage media containing computer-executable instructions for performing the various routines and providing the various display pages described above. For example, the memory 1205 can include a user interface component 1206 that contains the user interface display pages described above. The memory 1205 can also include a content database 1208 and a forms database 1210 that contain the content and forms described above relating to the various topics associated with recruiting foreign nationals. In one aspect of this embodiment, the memory 1205 can also include an information exchange component 1212. The information exchange component 1212 can include the various routines described above for determining which of the available content and forms are to be provided to the user computer for display or downloading by the user.

It will be appreciated from the foregoing that, although specific embodiments of the recruiting information exchange system have been described for purposes of illustration, various modifications may be made without deviating from the spirit or scope of the invention. Further, although the methods and systems have been described in the context of recruiting foreign nationals for employment by foreign divisions of domestic-based companies, it will be understood that the methods and systems are equally well suited for other types of employee recruitment in other types of situations. Those of ordinary skill in the relevant art will appreciate that these and other changes can be made to the invention in light of the above detailed description.

While certain aspects of the invention are presented below in certain claim forms, the inventors nevertheless contemplate various embodiments of the invention consistent with other claim forms. Accordingly, the inventors reserve the right to add additional claims after filing the application to pursue such additional claim forms for all aspects of the invention as contemplated. Further, the terms used in the following claims should not be construed to limit the invention to the specific embodiments disclosed in the specification or the claims, but instead should be construed to include all information exchange systems that operate in accordance with the claims to facilitate employee recruitment. The scope of the invention is therefore not limited by this disclosure, but instead, the scope of the invention is to be determined entirely by the following claims.

We claim:

1. A method in a computer system for providing information related to recruiting a foreign national employee for employment by a foreign division of a domestic-based company, the foreign division being located in a host country, the method comprising:
receiving a request for a user interface display page from a user computer;
in response to the received request, providing the requested user interface display page to the user computer, the requested user interface display page being configured to receive employee information;
receiving the employee information from the user computer; and
in response to the received employee information, providing recruiting information to the user computer.

2. The method of claim 1 wherein:
the requested user interface display page is configured to receive an employee type and a host country;
the received employee information includes the employee type and the host country; and
in response to receiving the employee type and the host country, information related to recruiting the employee type in the host country is provided to the user computer.

3. The method of claim 2 wherein the employee type is either leased or local national.

4. The method of claim 3 wherein the leased employee is an employee who is at least partially represented by an agent during the employment process, and the local national employee is an employee who is not represented by an agent during the employment process.

5. The method of claim 1 wherein, in response to the received employee information, a list of topics related to recruiting the foreign national employee is provided to the user computer, at least one of the topics being related to employee compensation, employee benefits, domestic-based training or visa preparations.

6. The method of claim 1 wherein, in response to the received employee information, a list of topics related to recruiting the foreign national employee is provided to the user computer, the method further comprising:
receiving a selection of at least one of the topics from the user computer; and
in response to receiving the at least one topic selection, providing information related to the at least one topic to the user computer.

7. The method of claim 6 wherein the provided information related to the at least one topic includes static content and at least one blank form.

8. The method of claim 6 wherein the provided information related to the at least one topic includes static content or at least one blank form.

9. The method of claim 6 wherein the provided information related to the at least one topic includes at least one blank form, the at least one blank form being configured to receive information related to the foreign national employee and being printable in hard copy form, electronically savable to a computer-readable medium and electronically transferable to a remote computer system.

10. The method of claim 6 wherein the provided information related to the at least one topic includes at least one blank form, the at least one blank form being configured to receive information related to the foreign national employee and being printable in hard copy form, electronically savable to a computer-readable medium or electronically transferable to a remote computer system.

11. The method of claim 6 wherein the provided information related to the at least one topic includes at least one blank form, the at least one blank form being configured to receive information related to the foreign national employee and being usable for procuring a visa.

12. The method of claim 6 wherein the provided information related to the at least one topic includes at least one blank form, the at least one blank form being configured to receive information related to the foreign national employee and being usable for determining tax status.

13. The method of claim 6 wherein the foreign division is located in the host country and the domestic-based company is based in a home country, and wherein the provided information related to the at least one topic includes information related to temporary relocation from the host country to the home country.

14. A method in a computer system for providing information related to employee recruitment, the method comprising:
receiving a request from a user computer for information related to recruiting a foreign national employee for employment in a foreign country;
in response to the received request, providing to the user computer information related to recruiting the foreign national employee for employment in the foreign country.

15. The method of claim 14 wherein:
the request for information related to recruiting the foreign national employee includes an employee type and the foreign country in which the foreign national employee will be employed; and
in response to receiving the employee type and the foreign country, information related to recruiting the employee type in the foreign country is provided to the user computer.

16. The method of claim 15 wherein the employee type is either leased or local national.

17. The method of claim 16 wherein the leased employee is an employee who is at least partially represented by an agent during the employment process, and the local national employee is an employee who is not represented by an agent during the employment process.

18. The method of claim 14 wherein, in response to the received request, a list of topics related to recruiting the foreign national employee is provided to the user computer, at least one of the topics being related to employee compensation, employee benefits, domestic-based training or visa preparations.

19. The method of claim 14 wherein, in response to the received request, a list of topics related to recruiting the foreign national employee is provided to the user computer, the method further comprising:
receiving a selection of at least one of the topics from the user computer; and
in response to receiving the at least one topic selection, providing information related to the at least one topic to the user computer.

20. The method of claim 19 wherein the provided information related to the at least one topic includes static content and at least one blank form.

21. The method of claim 19 wherein the provided information related to the at least one topic includes static content or at least one blank form.

22. The method of claim 19 wherein the provided information related to the at least one topic includes at least one blank form, the at least one blank form being configured to receive information related to the foreign national employee and being printable in hard copy form, electronically savable to a computer-readable medium and electronically transferable to a remote computer system.

23. The method of claim 19 wherein the provided information related to the at least one topic includes at least one blank form, the at least one blank form being configured to receive information related to the foreign national employee and being printable in hard copy form, electronically savable to a computer-readable medium or electronically transferable to a remote computer system.

24. The method of claim 19 wherein the provided information related to the at least one topic includes at least one blank form, the at least one blank form being configured to receive selected information related to the foreign national employee and being usable for procuring a visa.

25. The method of claim 19 wherein the foreign division is a foreign division of a domestic-based company, the domestic-based company being based in a home country, and wherein the provided information related to the at least one topic includes information related to temporary relocation from the foreign country to the home country for training.

26. A method in a user computer system for obtaining employee recruiting information from a server computer, the method comprising:
requesting a user interface display page from the server computer;
receiving the requested user interface display page from the server computer;
receiving employee information related to the received user interface display page from a user;
sending the received employee information to the server computer; and
in response to sending the received employee information, receiving employee recruiting information from the server computer.

27. The method of claim 26 wherein:
the user interface display page is configured to receive an employee type and a country;
the received employee information includes the employee type and the country; and
the received employee recruiting information includes information related to recruiting the employee type for employment in the country.

28. The method of claim 27 wherein the employee type is either leased or local national.

29. The method of claim 28 wherein the leased employee is an employee who is at least partially represented by an agent during the employment process, and the local national employee is an employee who is not represented by an agent during the employment process.

30. The method of claim 26 wherein, in response to sending the received employee information, a list of topics related to recruiting the employee is received from the server computer, at least one of the topics being related to employee compensation, employee benefits, domestic-based training or visa preparations.

31. The method of claim 26 wherein the method is usable for obtaining information related to recruiting a foreign national employee in a foreign country, wherein:
the user interface display page is configured to receive an employee type and a country;
the received employee information includes the employee type and the foreign country; and
the received employee recruiting information includes information related to recruiting the foreign national employee for employment in the foreign country.

32. The method of claim 26 wherein, in response to sending the received employee information, a list of topics related to recruiting the employee is received from the server computer, the method further comprising:
sending a selection of at least one of the topics to the server computer; and
in response to sending the at least one topic selection, receiving information related to the at least one topic from the server computer.

33. The method of claim 32 wherein the received information related to the at least one topic includes static content and at least one blank form.

34. The method of claim 32 wherein the received information related to the at least one topic includes static content or at least one blank form.

35. The method of claim 32 wherein the received information related to the at least one topic includes at least one blank form, the at least one blank form being configured to receive information related to the employee and being printable in hard copy form, electronically savable to a computer-readable medium and electronically transferable to a remote computer system.

36. The method of claim 32 wherein the received information related to the at least one topic includes at least one blank form, the at least one blank form being configured to receive information related to the employee and being printable in hard copy form, electronically savable to a computer-readable medium or electronically transferable to a remote computer system.

37. The method of claim 32 wherein the received information related to the at least one topic includes at least one blank form, the at least one blank form being configured to receive selected information related to the employee and being usable for procuring a visa.

38. A computer system for providing information related to recruiting a foreign national employee, the computer system comprising:
means for receiving a request for a user interface display page from a user computer;
means for providing the requested user interface display page to the user computer in response to the received request, the requested user interface display page being configured to receive employee information;
means for receiving the employee information from the user computer; and
means for providing employee recruiting information to the user computer in response to the received employee information.

39. The computer system of claim 38 wherein:
the requested user interface display page is configured to receive an employee type and a host country;
the received employee information includes the employee type and the host country; and
the provided recruiting information is related to recruiting the employee type in the host country.

40. The computer system of claim 39 wherein the employee type is either leased or local national.

41. The computer system of claim 40 wherein the leased employee is an employee who is at least partially represented by an agent during the employment process, and the local national employee is an employee who is not represented by an agent during the employment process.

42. The computer system of claim 38 wherein the provided recruiting information includes a list of topics related to recruiting the foreign national employee, at least one of the topics being related to employee compensation, employee benefits, domestic-based training or visa preparations.

43. The computer system of claim 38 wherein the provided recruiting information includes a list of topics related to recruiting the foreign national employee, the computer system further comprising:
means for receiving a selection of at least one of the topics from the user computer; and
means for providing information related to the at least one topic to the user computer in response to receiving the at least one topic selection.

44. The computer system of claim 43 wherein the provided information related to the at least one topic includes static content and at least one blank form.

45. The computer system of claim 43 wherein the provided information related to the at least one topic includes static content or at least one blank form.

46. The computer system of claim 43 wherein the provided information related to the at least one topic includes at least one blank form, the at least one blank form being configured to receive information related to the foreign national employee and being printable in hard copy form, electronically savable to a computer-readable medium and electronically transferable to a remote computer system.

47. The computer system of claim 43 wherein the provided information related to the at least one topic includes at least one blank form, the at least one blank form being configured to receive information related to the foreign national employee and being usable for procuring a visa.

48. A computer-readable medium containing a display page for receiving information related to a foreign national being recruited for employment by a foreign division of a domestic-based company, the display page comprising:
an employee type portion containing one or more fields for receiving information related to the foreign national; and
a country portion containing one or more fields for receiving information related to the country in which the foreign division is located.

49. The computer-readable medium of claim 48 wherein the employee type portion includes an employee type field configured to receive either leased or local national.

50. The computer-readable medium of claim 49 wherein the leased employee is an employee who is at least partially represented by an agent during the employment process, and the local national employee is an employee who is not represented by an agent during the employment process.

51. The computer-readable medium of claim 48 wherein:
the employee type portion includes an employee type field configured to receive either leased or local national, the leased employee being an employee who is at least partially represented by an agent during the employment process, the local national employee being an employee who is not represented by an agent during the employment process; and
the country portion includes a country identification field configured to receive at least one of India, Mexico or Russia.

52. The computer-readable medium of claim 48 further comprising a user information portion containing one or more fields for receiving information related to a user of the display page.

53. The computer-readable medium of claim 52 wherein the user information portion includes at least one of a name field configured to receive a name of the user and an email address field configured to receive an email address of the user.

54. A computer-readable medium whose contents cause a computer system to provide information related to recruiting a foreign national employee, the information being provided by a method comprising:
receiving a request for a user interface display page from a user computer;
in response to the received request, providing the requested user interface display page to the user computer, the requested user interface display page being configured to receive employee information;
receiving the employee information from the user computer; and
in response to the received employee information, providing recruiting information to the user computer.

55. The computer-readable medium of claim 54 wherein:
the requested user interface display page is configured to receive an employee type and a host country;
the received employee information includes the employee type and the host country; and
in response to receiving the employee type and the host country, information related to recruiting the employee type in the host country is provided to the user computer.

56. The computer-readable medium of claim 55 wherein the employee type is either leased or local national, the leased employee being an employee who is at least partially represented by an agent during the employment process, the local national employee being an employee who is not represented by an agent during the employment process.

57. The computer-readable medium of claim 54 wherein, in response to the received employee information, a list of topics related to recruiting the foreign national employee is provided to the user computer, at least one of the topics being related to employee compensation, employee benefits, domestic-based training or visa preparations.

58. The computer-readable medium of claim 54 wherein, in response to the received employee information, a list of topics related to recruiting the foreign national employee is automatically provided to the user computer, wherein the method further comprises:
receiving a selection of at least one of the topics from the user computer; and
in response to receiving the at least one topic selection, providing information related to the at least one topic to the user computer.

59. The computer-readable medium of claim 58 wherein the provided information related to the at least one topic includes static content and at least one blank form.

60. The computer-readable medium of claim 58 wherein the provided information related to the at least one topic includes static content or at least one blank form.

61. The computer-readable medium of claim 58 wherein the provided information related to the at least one topic includes at least one blank form, the at least one blank form being configured to receive selected information related to the foreign nation al employee and being printable in hard copy form, electronically savable to a computer-readable medium and electronically transferable to a remote computer system.

62. The computer-readable medium of claim 58 wherein the foreign national employee is being recruited for employment by a foreign division of a domestic-based company, the foreign division being located in a host country and the domestic-based company being based in a home country, and wherein the provided information related to the at least one topic includes information related to temporary relocation from the host country to the home country.
